(19) United States
(12) Patent Application Publication
(10) Pub. No.: US 2013/0240673 A1
(43) Pub. Date: Sep. 19, 2013

(54) ENABLING MULTIPLE AUTONOMOUS CARGO DELIVERIES IN A SINGLE MISSION

(71) Applicants: Kevin Schlosser, Owego, NY (US); Curt Eshbaugh, Little Meadows, PA (US); Joel Markham, Vestal, NY (US); Clifford T. Gunsallus, Canton, CT (US); James W. Bacon, Middletown, CT (US)

(72) Inventors: Kevin Schlosser, Owego, NY (US); Curt Eshbaugh, Little Meadows, PA (US); Joel Markham, Vestal, NY (US); Clifford T. Gunsallus, Canton, CT (US); James W. Bacon, Middletown, CT (US)

(21) Appl. No.: 13/780,826

(22) Filed: Feb. 28, 2013

Related U.S. Application Data
(60) Provisional application No. 61/605,539, filed on Mar. 1, 2012.

(51) Int. Cl. G05D 1/10; G05D 1/00; B64D 1/02

(52) U.S. Cl. CPC G05D 1/101; B64D 1/02; G05D 1/0011
USPC 244/137.1; 701/3

(57) ABSTRACT

Some embodiments of the invention provide methods and apparatus enabling multiple unmanned cargo deliveries in a single mission. An assembly having multiple hooks may be coupled to an unmanned vehicle via a cable. Prior to a mission originating at a starting location, multiple cargo loads may each be loaded on to a respective pallet, wrapped in a cargo delivery net, and attached to one of the hooks. A ground controller may instruct the unmanned vehicle to deliver the cargo loads to separate locations. The unmanned delivery vehicle may navigate to a first delivery location, perform delivery of a first cargo load by causing the hook on the assembly to release the first load, autonomously exit the first location and navigate to a second delivery location without returning to the starting location, and perform delivery of a second cargo load by causing the hook on the assembly to release the second load.

### RELATED APPLICATION

This application claims priority under 35 U.S.C. §119(e) to U.S. Provisional Patent Application Ser. No. 61/605,539, filed Mar. 1, 2012, bearing Attorney Docket No. L0562.70116US00, titled “Multiple Autonomous Cargo Deliveries,” the entirety of which is incorporated herein by reference.

### BACKGROUND

Manned convoys and cargo delivery via manned aircraft can be expensive and dangerous. As such, unmanned vehicles are sometimes employed to deliver cargo.

### SUMMARY

Conventional unmanned vehicles are limited to delivering a single load of cargo within a particular mission. For example, to deliver separate cargo loads to multiple destinations, a conventional unmanned aircraft picks up a first load for delivery at a base location, then travels to a first destination to drop off the first load, then returns to the base location to pick up a second load, then travels to a second destination to drop off the second load, then returns to the base location to pick up a third load for delivery, and so on.

Some embodiments of the invention provide a system which enables multiple unmanned cargo deliveries in a single mission. In some embodiments of the invention, a carousel assembly having multiple hooks may be coupled to an unmanned vehicle (e.g., a helicopter or other suitable transport vehicle) via a cable. Prior to a delivery mission, each of multiple cargo loads may be loaded on to a pallet and wrapped within a cargo delivery net which may then be attached to one of the hooks on the carousel assembly. Prior to or during the delivery mission, a ground controller may program the unmanned vehicle to deliver the cargo loads to separate locations. The unmanned delivery vehicle may navigate to a first delivery location, and perform delivery of a first load by releasing the hook on the carousel assembly which corresponds to the first load. After delivering the first load, the unmanned vehicle may autonomously exit the first location and navigate to a second delivery location, where a second load may be delivered via release of a hook on the carousel assembly which corresponds to the second load. After delivering the second load, the unmanned vehicle may (e.g., if more than two loads are to be delivered) exit the second location and travel to a third delivery location to deliver a third load by releasing a corresponding hook on the carousel assembly, and so on until all loads are delivered to corresponding locations, whereupon the unmanned vehicle may return to base, or travel to any other suitable location.

The ability to perform multiple unmanned cargo deliveries in a single mission may provide a number of benefits. For example, because the unmanned vehicle need not return to a base location after each cargo load is delivered to pick up additional cargo, fuel savings may be realized.

In addition, the delivery timeline for some cargo loads may be reduced. In this respect, the inventors contemplate that some embodiments of the invention may be deployed in a combat setting, in which military personnel may await delivery of cargo such as ammunition, weapons, blood plasma, etc. Use of a system which does not require a delivery vehicle to return to a base location after each cargo load is delivered may mean that cargo loads scheduled for delivery after a first cargo “drop” may arrive more quickly than when conventional approaches are used, since the delivery vehicle may travel directly to the delivery locations for those loads rather than having to return first to a base location. In certain circumstances, a quicker cargo delivery timeline may increase the probability of a combat mission's success, and/or save lives.

Additionally, some embodiments of the invention may reduce costs associated with maintaining a delivery vehicle. In this respect, an aircraft delivery vehicle typically is restricted to a finite number of startups and shutdowns (which usually correspond to a takeoff and landing) before the vehicle's engine is overhauled. Use of a system which enables cargo to be delivered to multiple locations, without a takeoff and landing at any location, before the vehicle returns to base means less startups and shutdowns, thereby increasing the number of delivery missions a vehicle may accomplish before its engine is overhauled.

### BRIEF DESCRIPTION OF DRAWINGS

FIG. 1 is a block diagram of an example system for performing multiple unmanned autonomous cargo deliveries in a single delivery mission, in accordance with some embodiments of the invention;

FIG. 2 depicts an example apparatus used to attach a carousel assembly to an unmanned delivery vehicle, in accordance with some embodiments of the invention;

FIG. 3 depicts an example carousel assembly which may be used to haul multiple cargo loads to different locations in a single delivery mission, in accordance with some embodiments of the invention;

FIG. 4 is a flow chart of an example process for performing multiple cargo deliveries to different locations in a single delivery mission, in accordance with some embodiments of the invention; and

FIG. 5 is a block diagram depicting an example computer which may be used to implement some aspects of embodiments of the invention.

### DETAILED DESCRIPTION

Some embodiments of the invention provide a system which enables multiple unmanned cargo deliveries to be performed in a single mission. In some embodiments, a carousel assembly having multiple hooks, or other suitable implement(s) for holding items, is attached to an unmanned vehicle (e.g., a helicopter or other suitable transport vehicle) via a cable known to those skilled in the art as a “long line.” Prior to a delivery mission, multiple cargo loads may each be loaded on to a different pallet, and each pallet may be enclosed within its own cargo delivery net. Each cargo net may then be attached to one of the hooks on the carousel assembly. For example, each cargo net may be attached to a different hook on the carousel assembly. The unmanned vehicle may be programmed to navigate to a first location to which a first load is to be delivered, descend to an altitude at which cargo touches the ground, deliver the first load by releasing a hook on the carousel assembly corresponding to the first load, ascend and travel directly to a second location at which a second load is to be delivered without returning to a base location, descend at the second location and deliver a second load by releasing a hook on the carousel assembly corresponding to the second load, and so on until deliveries are made at all desired locations. After all cargo loads have been delivered, the unmanned vehicle may return to a base location, or travel to any other suitable location, as desired.

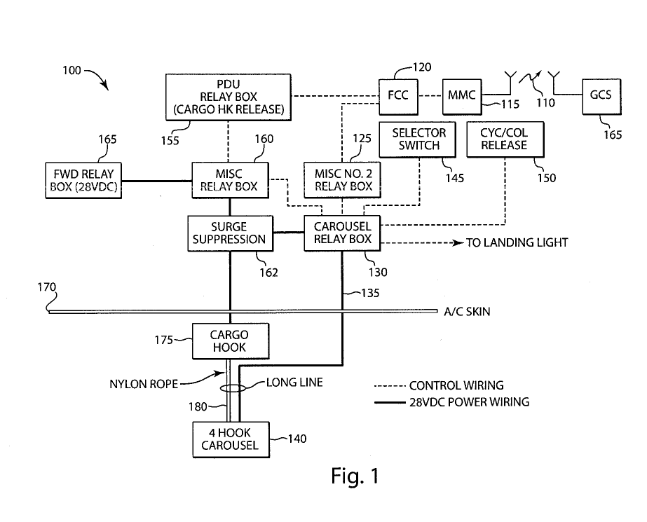

FIG. 1 shows an example system 100 for performing multiple unmanned cargo deliveries in a single mission. Example system 100 includes ground control station (GCS) 105, which may, for example, comprise a computing device operated by a user on the ground at a delivery location. For example, GCS 105 may enable personnel on the ground at a delivery location (e.g., a soldier, and/or other personnel) to issue instructions to an unmanned vehicle relating to cargo delivery. For example, when the user determines that the unmanned delivery vehicle (e.g., a helicopter) is in a proper location to descend, he/she may actuate a mechanism on GCS 105 to issue instructions to the unmanned vehicle to descend.

Of course, GCS 105 need not be operated by a user at a delivery location. For example, GCS 105 may be operated by a user at a base location to program a flight path for an unmanned delivery vehicle. GCS 105 may be used in any suitable location, and may have any of numerous uses.

In example system 100, GCS 105 communicates with mission management computer (MMC) 115, which resides on the unmanned vehicle, via link 110. Link 110 may comprise any one or more suitable communications links, employing any suitable infrastructure, technique(s) and/or protocol(s). In one example implementation, link 110 comprises multiple radio frequency (RF) data links, comprising one via a line of sight between GCS 105 and the unmanned vehicle, and one not requiring a line of sight (e.g., a satellite communication system). Any suitable configuration may be employed, as embodiments of the invention are not limited in this respect.

In addition to enabling GCS 105 to issue instructions to MMC 115, link 110 may, in some embodiments, enable MMC 115 to communicate various types of information to GCS 105. For example, MMC 115 may send to GCS 105 information relating to a state of the unmanned vehicle, its status, its location, and/or any other suitable type of information.

Upon receiving an instruction from GCS 105 via link 110, MMC 115 may route one or more instructions to one or more components of example system 110 to effect flight and/or delivery behavior. For example, MMC 115 may send information descriptive of a flight plan to flight control computer (FCC) 120, which may use the information to navigate the unmanned vehicle to a delivery location.

MMC 115 may also issue instructions to FCC 120 relating to delivery of cargo at a particular location. For example, upon receiving an instruction to descend from a user operating GCS 105 at a delivery location, MMC 115 may pass an instruction to FCC 120 to descend until a determination is made that the cargo carried by the carousel assembly is on the ground. This determination may, for example, be made using a strain gauge to identify when the cargo's weight is no longer borne by a long line attached to the vehicle. MMC 115 may issue an instruction to FCC 120 to cause a hook corresponding to a cargo load destined for the location to release the cargo load. FCC 120 may send a signal via miscellaneous relay box 125, carousel relay box 130 and umbilical line 135 to carousel assembly 140 to instruct carousel assembly 140 to cause the hook to release a cargo load. After the hook releases the cargo load and the cargo is delivered, MMC 115 may instruct FCC 120 to cause the unmanned vehicle to ascend and proceed to a next delivery location without first returning to a base location.

Example system 100 includes selector switch 145 and release controller 150. In this respect, some embodiments of the invention contemplate configuring a vehicle for both unmanned and manned operation. As such, selector switch 145 and release controller 150 may enable an operator of the vehicle to select a particular cargo load for release, and to release a hook corresponding to that cargo load, by issuing commands to carousel 140 via carousel relay box 130 and umbilical line 135.

Example system 100 includes power distribution unit (PDU) relay box 155, which distributes power to various components shown in FIG. 1, via miscellaneous relay boxes 125 and 160, which may comprise junction boxes that also route control signals to various components. Example system 100 also includes surge suppression 162, which ensures that, for example, a power surge does not cause carousel relay box 130 to issue an erroneous instruction to carousel assembly 140 to release a hook corresponding to a cargo load.

In example system 100, each of MMC 115 and FCC 120 comprises one or more general-purpose computers, although any suitable configuration of components may be employed. For example, in some embodiments, FCC 120 may include more than one general-purpose computer, to provide redundancy in case one of the computers fails during operation. In other embodiments, MMC 115 and FCC 120 may be implemented using a single general-purpose computer, one or more special-purpose computers, or any other suitable combination of components.

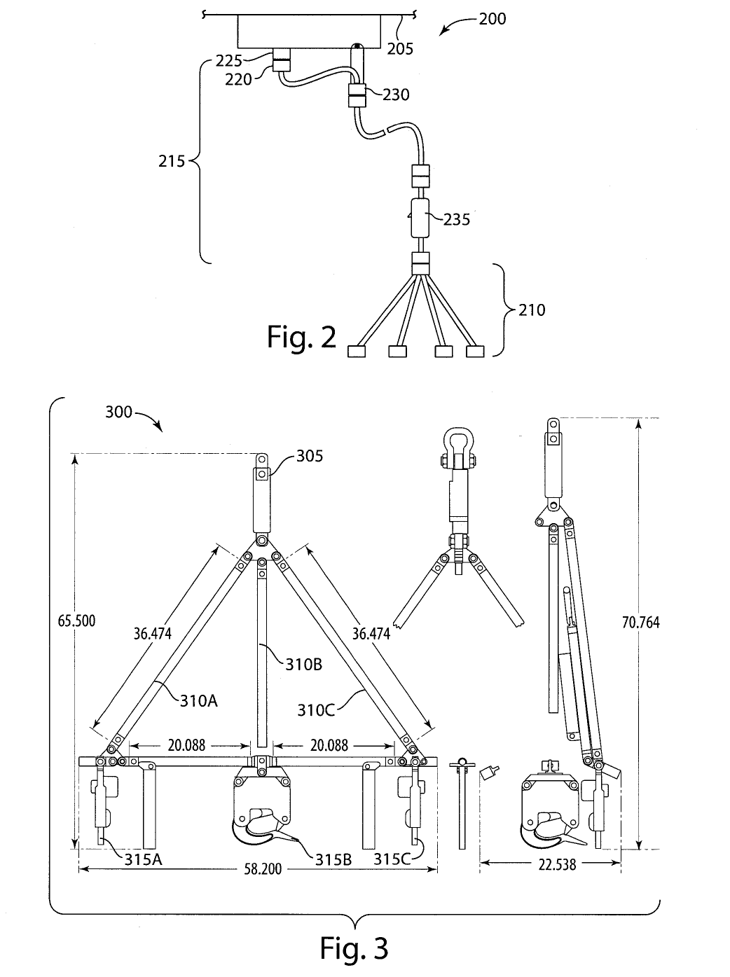

FIG. 2 depicts an example mechanism 200 for attaching a carousel assembly to a delivery vehicle. Example mechanism 200 includes an umbilical line 215, which in some embodiments may run the length of a long line used conventionally to attach a cargo hook to an unmanned vehicle. Connector plug 220 connects umbilical line 215 to connector 225, which in some embodiments may pass through hull 205 of the vehicle, allowing for power and control signals originating from within hull 205 (e.g., from components of example system 100, FIG. 1) to be transmitted to carousel assembly 210. Breakaway connector 230 enables slack in umbilical line 215 between connector 225 and connector 230, so that umbilical line 215 need not be taut. Breakaway connector 230 also allows umbilical line 215 to break away if circumstances dictate, such as if umbilical line 215 becomes entangled with an object on or rooted in the ground, or if hauled cargo otherwise endangers the vehicle and needs to be jettisoned. Swivel 235 allows carousel assembly 210 to swing and rotate, so that line 215 does not become tangled or twisted during use.

FIG. 3 depicts an example carousel assembly 300 onto which multiple independent cargo loads may be loaded. In the example shown, carousel assembly 300 includes four independent hooks for carrying four independent cargo loads. It should be appreciated, however, that embodiments of the invention are not limited to the particular implementation shown in FIG. 3. For example, a carousel assembly implemented in accordance with embodiments of the invention need not employ hooks to carry cargo loads, as any suitable mechanism may be used. If hooks are used, then any suitable number of hooks may be employed, and each hook may be adapted to carry any suitable number of cargo loads. Further, it should be appreciated that an assembly onto which multiple independent cargo loads are loaded need not take the form of a carousel, as any suitable structure(s) may alternatively be used, each of which may arrange attachment mechanisms (e.g., hooks) in any suitable manner.

Example carousel assembly 300 includes connector 305, which attaches example carousel assembly 300 to an unmanned vehicle, such as via example mechanism 200 (FIG. 2) and/or a long line. Three of the four arms (i.e., arms 310A, 310B and 310C) of example mechanism 300 are shown in FIG. 3, and each arm 310 extends from connector 305 to a respective hook. For example, arm 310A extends from connector 305 to hook 315A, arm 310B extends from connector 305 to hook 315B, and arm 310C extends from connector 305 to hook 315C. In some implementations, a cargo net (not shown) may enclose a cargo load and be attached to one of hooks 315. When a cargo load attached to a particular hook reaches its destination, a control signal may be issued to cause the hook may be retracted or to otherwise release the load, causing the cargo to be delivered.

It should be appreciated that embodiments of the invention are not limited to delivering cargo by releasing a hook when the cargo sits on the ground. For example, some embodiments of the invention may be adapted to drop a cargo load from a particular height, with the cargo load being equipped (e.g., via one or more parachutes) to descend gently. Any of numerous release arrangements may be envisioned by those skilled in the art.

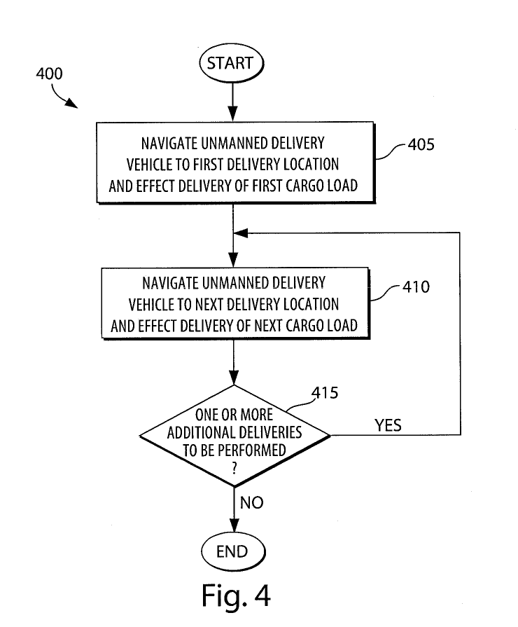

FIG. 4 depicts an example process 400 for performing multiple unmanned deliveries in a single mission. At the start of example process 400, an unmanned delivery vehicle is navigated to a first delivery location and delivery of a first cargo load is effected in act 405. After act 405 is completed, example process 400 proceeds to act 410, wherein the unmanned delivery vehicle is navigated to a next delivery location, without first returning to base, and delivery of a next cargo load is effected. For example, an unmanned delivery vehicle may travel directly from the first delivery location to a second delivery location, and deliver cargo at the second delivery location. When act 410 is completed, example process 400 proceeds to act 415, wherein a determination is made whether one or more additional deliveries are to be performed. If a determination is made in act 415 that at least one other delivery is to be performed, then example process 400 returns to act 410, and proceeds as described above. If it is determined that no more deliveries are to be performed, then example process 400 completes.

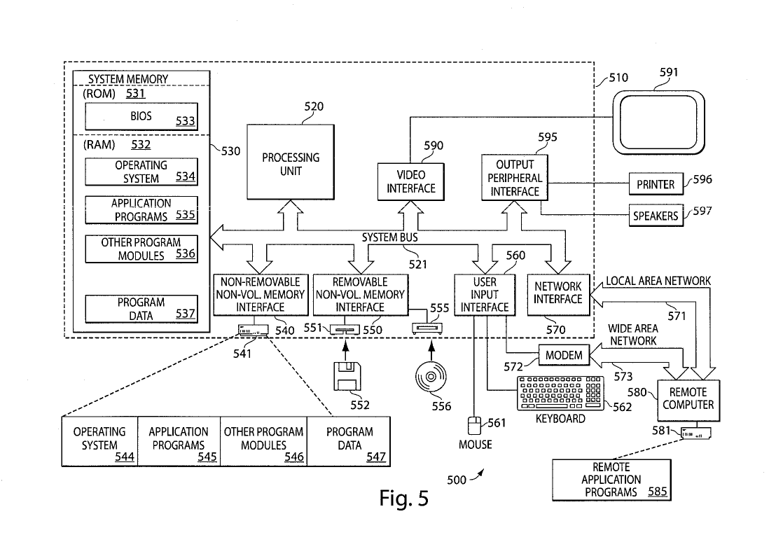

FIG. 5 illustrates an example of a suitable computing system 500 which may be used to implement aspects of the invention. The computing system 500 is only one example of a suitable computing system, and is not intended to suggest any limitation as to the scope of use or functionality of the invention. Neither should the computing system 500 be interpreted as having any dependency or requirement relating to any one or combination of components illustrated in the exemplary system 500.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system for implementing the invention includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through an non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through a output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein. Accordingly, the foregoing description and drawings are by way of example only.

Embodiments of the present invention may be implemented in any of numerous ways. For example, embodiments of the invention may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, or using circuitry in any other suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, an example of which has been described. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising acts of:
(A) causing an unmanned vehicle to travel from a starting location to a first delivery location;
(B) causing the unmanned vehicle to deliver a first cargo load at the first delivery location;
(C) causing the unmanned vehicle to travel from the first delivery location to a second delivery location, without returning to the starting location prior to arriving at the second delivery location; and
(D) causing the unmanned vehicle to deliver a second cargo load at the second delivery location.

2. The method of claim 1, for use in a system comprising an assembly having a plurality of hooks, a first hook of the plurality of hooks holding the first cargo load and a second hook of the plurality of hooks holding the second cargo load, wherein the act (B) comprises causing the first hook to release the first cargo load at the first delivery location, and the act (D) comprises causing the second hook to release the second cargo load at the second delivery location.

3. The method of claim 1, wherein the system comprises at least one computer in communication with the assembly, wherein the act (B) comprises the at least one computer issuing a first instruction to the assembly to cause the first hook to release the first cargo load at the first delivery location, and wherein the act (D) comprises the at least one computer issuing a second instruction to the assembly to cause the second hook to release the second cargo load at the second delivery location.

4. The method of claim 3, wherein the at least one computer issues the first instruction and the second instruction in response to input being received from a human operator.

5. The method of claim 4, wherein the human operator is located at the starting location.

6. The method of claim 1, wherein the unmanned vehicle comprises an aircraft.

7. The method of claim 6, wherein the aircraft comprises a helicopter.

8. At least one computer for enabling an unmanned vehicle to deliver a plurality of separate cargo loads in a single delivery mission, the plurality of cargo loads being loaded to the unmanned vehicle at a starting location, the at least one computer comprising:
at least one processor programmed to;
cause an unmanned vehicle to travel from a starting location to a first delivery location;
cause the unmanned vehicle to deliver a first cargo load at the first delivery location;
cause the unmanned vehicle to travel from the first delivery location to a second delivery location, without returning to the starting location prior to arriving at the second delivery location; and
cause the unmanned vehicle to deliver a second cargo load at the second delivery location.

9. The at least one computer of claim 8, wherein the at least one processor is programmed to cause the unmanned vehicle to deliver a first cargo load at the first delivery location in response to input received from a human operator upon the unmanned delivery vehicle arriving at the first cargo delivery location.

10. The at least one computer of claim 9, wherein the at least one processor is programmed to cause the unmanned vehicle to deliver a second cargo load at the second delivery location in response to input received from a human operator upon the unmanned delivery vehicle arriving at the second cargo delivery location.

11. The at least one computer of claim 10, wherein the human operator from whom input is received upon the unmanned delivery vehicle delivering a first cargo load at the first cargo delivery location is different than the human operator from whom input is received upon the unmanned delivery vehicle delivering the second cargo load at the second cargo delivery location.

12. The at least one computer of claim 11, wherein the human operator from whom input is received upon the unmanned delivery vehicle delivering the first cargo load at the first cargo delivery location is located at the first cargo delivery location, and the human operator from whom input is received upon the unmanned delivery vehicle delivering the second cargo load at the second cargo delivery location, is located at the second cargo delivery location.

13. The at least one computer of claim 9, wherein the human operator is located at the starting location.

14. The at least one computer of claim 8, wherein the at least one processor is in communication with an assembly having a plurality of hooks, a first hook of the plurality of hooks holding the first cargo load and a second hook of the plurality of hooks holding the second cargo load, and wherein the at least one processor is programmed to cause the assembly to effect delivery of the first cargo load by releasing the first hook at the first delivery location, and to effect delivery of the second cargo load by releasing the second hook at the second delivery location.

15. The at least one computer of claim 8, wherein the assembly comprises a strain gauge which makes information available to the at least one computer relating to weight borne by the assembly, and wherein the at least one processor is programmed to instruct the assembly to release the first hook when information made available by the strain gauge indicates that the first cargo load's weight is no longer borne by the assembly at the first delivery location, and to instruct the assembly to release the second hook when information made available by the strain gauge indicates that the second cargo load's weight is no longer borne by the assembly at the second delivery location.

16. At least one computer-readable storage device having instructions recorded thereon which, when executed by at least one computer, perform a method of enabling an unmanned vehicle to deliver a plurality of separate cargo loads in a single delivery mission, the plurality of cargo loads being loaded to the unmanned vehicle at a starting location, the method comprising acts of:
(A) causing an unmanned vehicle to travel from a starting location to a first delivery location;
(B) causing the unmanned vehicle to deliver a first cargo load at the first delivery location;
(C) causing the unmanned vehicle to travel from the first delivery location to a second delivery location, without returning to the starting location prior to arriving at the second delivery location; and
(D) causing the unmanned vehicle to deliver a second cargo load at the second delivery location.

17. The at least one computer-readable storage device of claim 16, wherein at least one of the acts (A), (B), (C) and (D) are performed in response to input from a human operator being received at the at least one computer.

18. The at least one computer-readable storage device of claim 16, wherein at least one of the acts (A) and (B) is performed in response to input being received from a first human operator, and at least one of the acts (C) and (D) is performed in response to input being received from a second human operator.

19. The at least one computer-readable storage device of claim 16, wherein the unmanned vehicle comprises an assembly having a plurality of hooks, a first hook of the plurality of hooks holding the first cargo load and a second hook of the plurality of hooks holding the second cargo load, and wherein the act (B) comprises issuing an instruction to the assembly to release the first hook at the first delivery location, and the act (D) comprises issuing an instruction to the assembly to release the second hook at the second delivery location.

20. The at least one computer-readable storage device of claim 19, wherein the assembly comprises a strain gauge which makes available information relating to weight borne by the assembly, and wherein the act (B) comprises issuing the instruction when information made available by the strain gauge indicates that the first cargo load's weight is no longer borne by the assembly at the first delivery location, and the act (D) comprises issuing the instruction when information made available by the strain gauge indicates that the second cargo load's weight is no longer borne by the assembly at the second delivery location.
